(19) United States
(12) Patent Application Publication
(10) Pub. No.: US 2026/0326733 A1
(43) Pub. Date: Oct. 22, 2026

(54) BRAKING SYSTEM, IN PARTICULAR A WIRE BRAKING SYSTEM, COMPRISING A MASTER CYLINDER, IN PARTICULAR A TANDEM MASTER CYLINDER

(71) Applicant: Robert Bosch GmbH, Stuttgart (DE)

(72) Inventors: Carole Charpentier, Montmorency (FR); Florent Yvonet, Trilport (FR); Hugo Vazquez, Poissy (FR); Moustafa Lachgar, Franconville (FR); Nicolas Quiniou, Villemomble (FR)

(21) Appl. No.: 19/637,239

(22) Filed: Apr. 2, 2026

(30) Foreign Application Priority Data
Apr. 15, 2025 (FR) 2504028

(51) Int. Cl. B60T 13/74; B60T 13/16; B60T 13/66

(52) U.S. Cl. CPC B60T 13/745; B60T 13/166; B60T 13/662; B60T 2270/306; B60T 2270/402

(57) ABSTRACT

A braking system. The braking system includes a master cylinder formed by a base body of substantially cylindrical shape defining within it an interior space in which at least one piston moves under the thrust of an actuator. The interior space of the master cylinder is in communication, via at least one inlet manifold, with a brake fluid reservoir, and, via at least one outlet manifold, with at least one hydraulic braking circuit acting on the brakes. At least one suction valve is provided, arranged in the fluid path between the brake fluid reservoir and the at least one outlet manifold, and an electronic ESP controller is provided which is capable of controlling a pump to create a vacuum for opening the at least one suction valve, and a fastener is provided for the at least one suction valve, the fastener including an elastic C-ring.

### FIELD

The present disclosure relates to a braking device comprising a master cylinder, in particular a tandem master cylinder (TMC), as well as to a master cylinder or TMC of this kind.

### BACKGROUND INFORMATION

The braking system is a critical component in vehicle safety, ensuring effective deceleration and control under a wide range of driving conditions. Conventional braking systems, especially those using a master cylinder, in particular a tandem master cylinder, without an additional mechanism, often face fluid transfer efficiency limitations in specific use cases. Conventional master cylinder designs rely on moving pistons within sealed areas to displace brake fluid, which can lead to restricted flow, especially under extreme conditions. Thus, at very low temperatures, the viscosity of the brake fluid increases, further restricting its movement in the system. This limitation can lead to reduced braking efficiency and increase the risk of brake failure.

Today's braking systems mainly use a master cylinder and associated components which operate on hydraulic principles. Existing solutions do not adequately address the problem of fluid viscosity in cold temperatures or the need to increase fluid intake during emergency situations. This is particularly the case for wire braking (or brake by wire) systems, where relying on electrical signals to actuate braking introduces specific difficulties which the present disclosure also aims to overcome. The aim is thus to improve the ability of current braking systems to operate effectively under unfavorable conditions, particularly in the case of so-called wire braking systems, in which the connection between the brake pedal and the master cylinder is entirely electrical and in which, in the event of an electrical fault, the driver loses the ability to mechanically press the master cylinder to generate the necessary braking pressure on the piston.

### SUMMARY

The present disclosure aims to overcome the drawbacks of the related art by providing a braking system comprising a master cylinder, in particular a TMC, formed by a base body of substantially cylindrical shape defining within it an interior space in which at least one piston moves under the thrust of an actuator, the movement of the actuator being controlled by a brake pedal, either via a booster arranged between the actuator and the brake pedal and controlled electronically by an electrical unit, or, if the booster fails, directly via the mechanical connection to the pedal, or via an electrical wire connection between the pedal and the electrical unit controlling an electric motor acting on the actuator, the interior space of the master cylinder being in communication, via at least one inlet manifold, with a brake fluid reservoir, and, via at least one outlet manifold, with at least one hydraulic braking circuit acting on the brakes, characterized in that at least one suction valve is provided, arranged in the fluid path between the brake fluid reservoir and the at least one outlet manifold, and an electronic ESP controller is provided which is capable of controlling a pump to create a vacuum for opening the at least one suction valve, and fastening means are provided for the at least one suction valve, the means comprising an elastic C-ring.

By providing a suction valve in this way, the ESP can supplement, or even replace in the most critical cases, the action of pressurizing the fluid by means of the piston, in particular in the event of the piston failing, in order to thus act on the brakes. In particular, this ensures that, as the brake fluid viscosity increases, the system can still maintain optimum fluid flow and pressure. Similarly, in the event of an electrical fault, the emergency mode can be activated, allowing a significant supply of brake fluid to ensure effective braking. Furthermore, because the valve is securely fastened, the risk of unintended movement of the valve is minimized or even eliminated, thereby ensuring reliable and optimal operation of the pressurized fluid flow action on the brakes, particularly under extreme or emergency conditions.

This improves the fluid intake capacity of the braking system.

In particular, the result is a braking system with improved braking performance and greater ease of use, which is also particularly well suited to wire braking.

Thus, according to one example embodiment, the movement of the mechanical actuator is controlled by an electrical unit that receives a signal from the brake pedal via an electrical wire, with which signal the electrical unit determines the braking force and consequently controls the corresponding action of the actuator via an electric motor.

In another example embodiment, the brake pedal sends a signal to the ESP via an electrical wire, with which signal the ESP determines the braking force and consequently controls the corresponding pump action via an electric motor.

The two example embodiments described above can be used in combination, or on their own.

Preferably, the at least one suction valve is received in a particular inlet manifold of the master cylinder or in a bypass channel of the at least one particular inlet manifold, and an inner annular shoulder is formed in the inner wall of the inlet manifold or bypass channel, against which wall rests a face, facing toward the interior space, of the particular suction valve received in the particular inlet manifold or channel.

Preferably, a recess in the form of an annular groove is formed in the inner wall, on the side opposite the interior space of the annular shoulder, in which recess the C-ring is received in a form-fitting manner.

Preferably, the ring has a substantially rectangular or square cross-sectional shape.

Preferably, the corners of the square or rectangular shape have a particular shape that extends between the two straight segments that meet to form the corner, the distance measured along one segment between the end of the segment and the virtual continuation of the other segment preferably being less than 0.15 mm but greater than 0.03 mm.

In particular, in the case of corners rounded in a circular arc shape, the radius is less than 0.15 mm and greater than 0.03 mm.

Preferably, the corners have a shape corresponding to that of the corners of the annular groove in which the ring is received.

Preferably, an intermediate annular recess is formed in the inner wall, between the annular shoulder and the annular groove-shaped recess in which the C-ring is received in a form-fitting manner, this intermediate annular recess receiving an O-ring seal.

Preferably, the O-ring seal is pressed radially against the bottom of the intermediate annular groove by a side face of the particular valve press-fitted against the O-ring.

Preferably, the C-ring bears against the face of the valve facing away from the interior space.

In particular, the at least one valve is received in a particular inlet manifold and a bypass channel is provided extending from a portion of the inlet manifold upstream of the particular valve to the interior space of the master cylinder, in particular the TMC.

According to another preferred example embodiment, the at least one suction valve is arranged in a bypass channel extending between the at least one inlet manifold and the interior space or the at least one outlet manifold.

According to a preferred example embodiment, the at least one bypass channel is made up of a main through-hole between the outside of the base body and the at least one outlet manifold, and an auxiliary through-hole extending between the at least one inlet manifold and the main through-hole.

Preferably, the at least one suction valve is located in the main through-hole.

Preferably, the main through-hole has a longitudinal axis parallel to that of the at least one inlet manifold.

According to one example embodiment, the main through-hole extends from the upper side of the master cylinder and is closed at the top by a press-fit ball.

The present disclosure also relates to a master cylinder, in particular intended to form part of a braking system according to the present disclosure, the master cylinder, in particular TMC, being formed by a base body of substantially cylindrical shape defining within it an interior space in which at least one piston can move, the interior space of the master cylinder being able to be placed in communication, via at least one inlet manifold, with a brake fluid reservoir, and, via at least one outlet manifold, with at least one hydraulic braking circuit acting on the brakes, characterized in that at least one suction valve, arranged in the base body, is provided in the fluid path between the brake fluid reservoir and the at least one outlet manifold, and fastening means are provided for the at least one suction valve, the means comprising an elastic C-ring.

By way of example, the figures show preferred example embodiments of the present disclosure.

### BRIEF DESCRIPTION OF THE DRAWINGS

FIG. 1 is a schematic representation of a vehicle comprising a mechanical braking system comprising a booster.

FIG. 2 is a schematic representation of a vehicle comprising a wire braking system.

FIG. 3 is a longitudinal cross-sectional view of part of a tandem master cylinder (TMC) according to one example embodiment of the present disclosure.

FIG. 4 is a larger-scale view of part of FIG. 3.

FIG. 5 is a larger-scale view of part of FIG. 4.

FIG. 6 is a perspective view of the C-ring shown in the previous figures.

### DETAILED DESCRIPTION OF EXAMPLE EMBODIMENTS

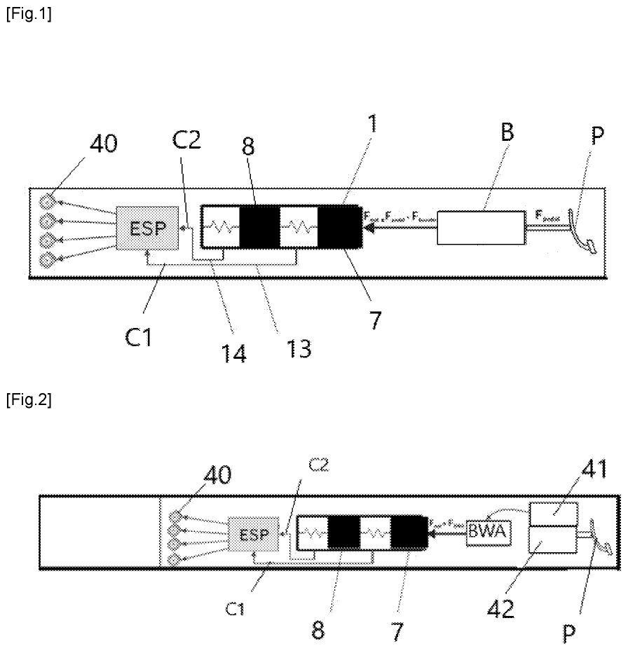

FIG. 1 schematically shows a motor vehicle in which the driver acts (F_{pedal}) on a pedal P to control, via an electrical unit, a booster B (Fout=F_{pedal}+F_{booster}) acting on a primary piston moving in an interior space of a TMC 1 comprising two outlet manifolds 13 and 14, primary and secondary respectively, in communication with the hydraulic braking circuits C1 and C2, under the control of an ESP, which act on the brake calipers 40.

Should the actuator and/or booster fail, the driver still has the option of pushing the piston directly (known as the “push thru” function).

The ESP receives a braking signal from the pedal, via a sensor and the electrical unit, and on the basis of this signal the ESP can control a pump to open two suction valves, namely a primary valve 15 and secondary valve 16 respectively, located in the TMC 1, between the fluid reservoir 10 and two respective primary 11 and secondary 12 inlet manifolds, to thus, in the event of an emergency or actuator failure, hydraulically control braking or supplement it.

FIG. 2 schematically shows a motor vehicle in which the driver acts on a pedal P to control, via an electrical unit, a booster acting (Fout=F_{BWA}) on a primary piston moving in an interior space of a TMC 1 comprising two outlet manifolds 13 and 14, primary and secondary respectively, in communication with the hydraulic braking circuits, under the control of an ESP.

The BWA actuator is not mechanically linked to the pedal, and its movement is controlled by an electric motor controlled by the electrical unit 41 on the basis of a signal received from a sensor 42 which determines, from the pedal travel and the force applied by the driver, the desired braking.

If the actuator fails, the driver cannot push the piston directly (the “push-thru” function is not available).

The ESP receives a braking signal from the pedal, via a sensor and the electrical unit, and on the basis of this signal the ESP can control a pump to open two suction valves, namely a primary valve 15 and secondary valve 16 respectively, located in the TMC 1, between the fluid reservoir 10 and two respective primary 11 and secondary 12 inlet manifolds having a vertical axis, to thus, in the event of an emergency or actuator failure, hydraulically control braking or supplement it.

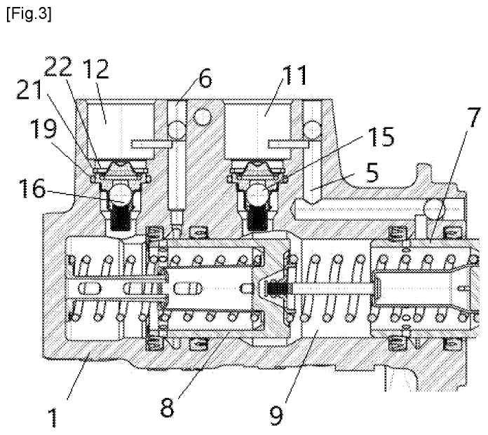

FIG. 3 shows that the TMC 1 comprises two primary 7 and secondary 8 pistons which move back and forth in the interior space 9 of the cylinder under the thrust of an actuator (not shown) to create a hydraulic pressure transmitted to respective brake circuits, via the two primary 13 and secondary 14 outlet manifolds.

The two inlet manifolds, namely the primary 11 manifold and secondary manifold 12, respectively, connect the brake fluid reservoir to the interior space 9, respectively.

In addition, two primary 5 and secondary 6 bypass channels, respectively, connect the inlet manifolds upstream of the valves to the interior space 9. These channels also open to the outside of the cylinder body, in particular as shown at the top, and are plugged by balls force-fitted from above.

Each of these two channels 5 and 6 opens out into the interior space and each allows brake fluid to pass from the reservoir into the interior space when the two pistons are in the rest position, not pushed by the actuator, and no braking is required. Thus, in normal system operation, they provide the fluid supply for action on the brakes, when the two pistons, under the action of the actuator, increase the pressure in the interior space.

In addition, a relevant suction valve 15 and 16 is arranged in each inlet manifold, allowing, when the ESP operates a pump (not visible in the figures), additional communications between the reservoir and the interior space to be opened, which are not prevented by the position of the pistons being undesirably depressed, in particular blocked, in the depressed position.

In addition, in the case of normal piston operation, these valves make it possible, by suction, to increase the quantity of brake fluid which is sent into the interior space, thus improving brake fluid flow and therefore braking effectiveness, in particular under extreme conditions which have a negative influence on flow, for example by increasing fluid viscosity.

The inner walls of both the primary and secondary inlet manifolds 11, 12 have a shoulder 17 against which rests a face 18, facing the interior space 9, of the particular valve received in the particular manifold.

Above (i.e. on the side opposite the interior space) the shoulder 17, a recess in the form of an annular groove 21 is formed, in which an elastic C-ring 22 is received in a form-fitting manner.

The C-ring 22 has a square cross-section with rounded corners.

The face 23 of the ring, facing the interior space 9 and the valve, bears against the face of the valve on the side opposite the interior space 9.

In this way, the valve is kept in a stable position, allowing high flow reliability as controlled by the ESP.

Between the shoulder 17 and the annular recess 21, an intermediate recess in the form of an annular groove 24 is formed, in which an O-ring seal 19 is received.

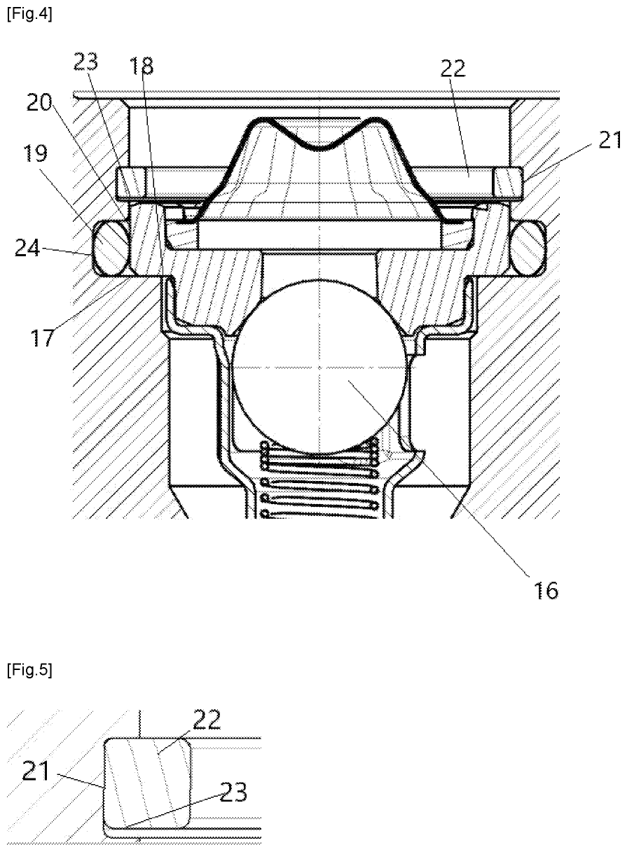

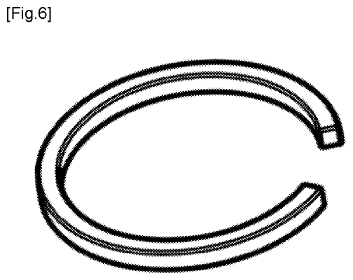

A lateral annular face 20 of the particular valve rests laterally against the O-ring to compress it sufficiently to achieve sealing, the sealing being such that the brake fluid cannot pass from bottom to top in the figure beyond the O-ring (see the arrows in FIG. 4).

To achieve this sealing, the valve is force-fitted against the seal, which is then deformed by being pushed sideways to become elliptical in cross-section as shown in the figures.

In particular, the TMC body can be made of a metal material, such as aluminum. The valve can be made of steel.

1-12. (canceled)

13. A braking system: comprising:
a master cylinder formed by a base body of cylindrical shape defining within it an interior space in which at least one piston moves under the thrust of an actuator, a movement of the actuator being controlled by a brake pedal, either: (i) via a booster arranged between the actuator and the brake pedal and controlled electronically by an electrical unit, or (ii) if the booster fails, directly via a mechanical connection to the pedal, or (iii) via an electrical wire connection between the pedal and the electrical unit controlling an electric motor acting on the actuator, the interior space of the master cylinder being in communication, via at least one inlet manifold, with a brake fluid reservoir, and, via at least one outlet manifold, with at least one hydraulic braking circuit acting on brakes;
wherein at least one suction valve is arranged in a fluid path between the brake fluid reservoir and the at least one outlet manifold, and an electronic ESP controller is provided which is capable of controlling a pump to create a vacuum for opening the at least one suction valve, and a fastener is provided for the at least one suction valve, the fastener including an elastic C-ring.

14. The braking system according to claim 13, wherein the master cylinder is a tandem master cylinder (TMC).

15. The system according to claim 13, wherein the movement of the actuator is controlled by an electrical unit that receives a signal from the brake pedal via an electrical wire, the electrical unit determining, using the received signal from the brake pedal, a braking force and the electrical unit consequently controlling a corresponding action of the actuator via an electric motor.

16. The system according to claim 13, wherein the brake pedal sends a signal to the electronic ESP controller via an electrical wire, and wherein the electronic ESP controller determines, using the signal from the brake pedal, a braking force and the electronic ESP controller consequently controls a corresponding pump action via an electric motor.

17. The system according to claim 13, wherein the at least one suction valve is received in a particular inlet manifold of the master cylinder or in a bypass channel of the at least one inlet manifold, and an inner annular shoulder is formed in an inner wall of the particular inlet manifold or the bypass channel, wherein a face, facing toward the interior space, of the at least one suction valve received in the particular inlet manifold or the bypass channel, rests against the inner annular shoulder.

18. The system according to claim 17, wherein a recess in the form of an annular groove is formed in the inner wall, on a side opposite the interior space of the annular shoulder, wherein the C-ring is received in a form-fitting manner in the recess.

19. The system according to claim 18, wherein the C-ring has a rectangular cross-sectional shape or square cross-sectional shape.

20. The system according to claim 19, wherein corners of the square shape or corners of the rectangular shape each have a shape which extends between two straight segments which join to form a particular corner, a distance measured along one segment of the two straight segments between an end of the one segment and a virtual continuation of the other segment of the two straight segments being less than 0.15 mm and greater than 0.03 mm.

21. The system according to claim 20, wherein the corners have a shape corresponding to that of corners of the annular groove in which the C-ring is received.

22. The system according to claim 18, wherein an intermediate annular recess, in which an O-ring seal is received, is formed in the inner wall, between the annular shoulder and the annular groove in which the C-ring is received in a form-fitting manner.

23. The system according to claim 22, wherein the O-ring seal is pressed radially against a bottom of the intermediate annular groove by a side face of the particular suction valve press-fitted against the O-ring.

24. The system according to claim 13, wherein the C-ring bears against a face of the at least one suction valve facing away from the interior space.

25. A master cylinder for a braking system, the master cylinder being formed by a base body of cylindrical shape defining within it an interior space in which at least one piston can move, the interior space of the master cylinder being able to be placed in communication, via at least one inlet manifold, with a brake fluid reservoir, and, via at least one outlet manifold, with at least one hydraulic braking circuit acting on brakes, wherein at least one suction valve is arranged in the base body in a fluid path between the brake fluid reservoir and the at least one outlet manifold, and a fastener is provided for the at least one suction valve, the fastener including an elastic C-ring.
